(19) United States
(12) Patent Application Publication
(10) Pub. No.: US 2015/0379096 A1
(43) Pub. Date: Dec. 31, 2015

(54) SYSTEM AND METHOD FOR AUTOMATICALLY CONNECTING MULTIPLE, DISTINCT TABLES OF A DATA REPOSITORY

(71) Applicant: KPMG LLP, New York, NY (US)

(72) Inventors: Garrett Flynn, Chicago, IL (US); Josh Close, New York, NY (US); Ajay Narayan, Portland, OR (US); Brian Moon, New York, NY (US); Lindsay Williams, New York, NY (US); Alex Lamar, New York, NY (US); Lijo Johnson, Short Hills, NJ (US); Narasimhan Kanvar, Philadelphia, PA (US); Tim Tantillo, Philadelphia, PA (US); David Fourie, New York, NY (US)

(21) Appl. No.: 14/316,610

(22) Filed: Jun. 26, 2014

(51) Int. Cl. G06F 17/30

(52) U.S. Cl. CPC G06F 17/30563; G06F 17/30292

(57) ABSTRACT

A system and method for automatically establishing connections to tables within a data repository may include establishing a pointer to a data repository inclusive of a plurality of tables. System-level metadata within a data repository, catalog, and tables may be accessed. Connections for the respective tables inclusive of data values and metadata associated with the data values may be automatically created.

### BACKGROUND

Information management systems are used extensively throughout business to manage information and operations. For example, multi-national companies and other organizations (e.g., governmental) or enterprises typically have many individual office sites that have respective information systems that manage local operations. The enterprises generally have a need to be able to collect the information from each of the office sites to be able to create enterprise-level views or reports for management, investors, and government regulators. Large enterprises typically allow the local operations to create and/or manage their respective information management systems. Even when large enterprises have certain central information management systems, it is still quite common that regional operations operate independently from other regional operations with regard to information management. As a result, for large enterprises to collect and manage the massive amount of management and operational data that is typical in today's business world, large-scale information management systems with data repositories that have many tables are utilized. In some cases, a common data repository, such as SAP, Oracle, or other commercial data repository is used. In other cases, multiple, different data repositories are used within the same enterprise. In either case, many tables are often created by the data repositories so that certain processing functions, such as searching, operate faster. The reason for the speed increase is generally due having less data within each table (i.e., “thinner” tables”).

More particularly, processing large-scale data repositories that include one or more different data structures for storing data is time-consuming. Such large-scale data repositories may include upwards of 100,000 tables. Currently, a process for pointing or creating connections to each table within the large-scale data repositories so that data in each of the tables can be accessed is a manual process, and may take five minutes or more for connecting to each table. Both extract, transform, and load (ETL) and Big Data approaches require manual efforts to set-up each individual connection to each table. Moreover, as data repositories and/or enterprises grow and add more data repositories, the difficulty of keeping track of which table connections have been created for future enterprise-level data collection efforts grows.

### SUMMARY

The principles of the present invention provide for a system and process that allows for identifying tables within a large-scale data repository and automatically creating connections to the tables so that a data collection process may utilize those connections. In identifying the tables, two process options are possible, including undirected and directed processes. The undirected process may be performed by the system receiving a connection parameters of a data repository, and automatically determining a list of all tables in the data repository across schemas. The directed process provides a specific list of tables in the data repository to use. In performing the undirected process, a connection string to each data repository may be used to establish access to system-level metadata of the one or more data repositories. A catalog may be read from each data repository in which enterprise data, such as management and operational data, may be accessed, where the catalog(s) provide a list of tables of each data repository. Connection strings to the tables may be created and stored in a data file or other storage location. The directed process may be performed by processing specific table information of a subset of tables in a data repository as provided via an input file, and creating connection strings for each of the tables listed in the input file. It should be understood that the principles of the present invention may be applied to one or more data repositories in a parallel or serial manner.

One embodiment of a method for automatically establishing connections to tables within a data repository may include establishing a pointer to a data repository inclusive of a plurality of tables. Connection data for the respective tables, which are inclusive of data values and metadata associated with the data values, may be automatically created. In one embodiment, system-level metadata may be accessed within a catalog of the data repository, and the system-level metadata may include the connection data. The connection data may be inclusive of a table ID, table type, and/or other information associated with the tables that provides the ability to create a connection to a table. Inclusive of metadata for the respective tables may be a current version of the metadata so that as tables and metadata associated with the tables change, that the metadata associated with the tables may be retained at each date and time that the process is performed. Connection data associated with a plurality of tables may be identified within the system-level metadata. In an alternative embodiment, a subset of the tables may be provided to the process in a file so that connections to the subset of tables may be automatically created at run-time.

Another embodiment of a method for automatically establishing connections to tables within a data repository may include establishing a pointer to a data repository inclusive of a plurality of tables. Connections for the respective tables inclusive of connection parameters and metadata for each of the tables may be automatically created. Yet another embodiment of a method for automatically establishing connections to tables within a data repository may include establishing a pointer to a data repository inclusive of a plurality of tables. A catalog of the data repository may be accessed. Table names may be read from the catalog, and connections for the respective tables.

### BRIEF DESCRIPTION

A more complete understanding of the method and apparatus of the present invention may be obtained by reference to the following Detailed Description when taken in conjunction with the accompanying Drawings wherein:

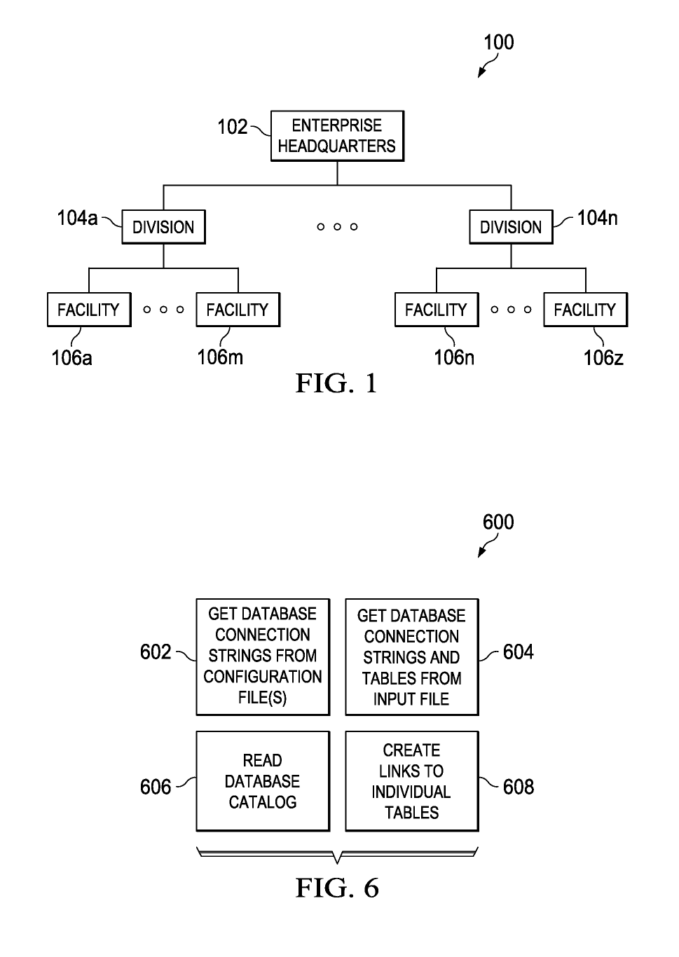

FIG. 1 is an illustration of an illustrative hierarchical structure of an enterprise, such as a corporation or governmental entity (enterprise);

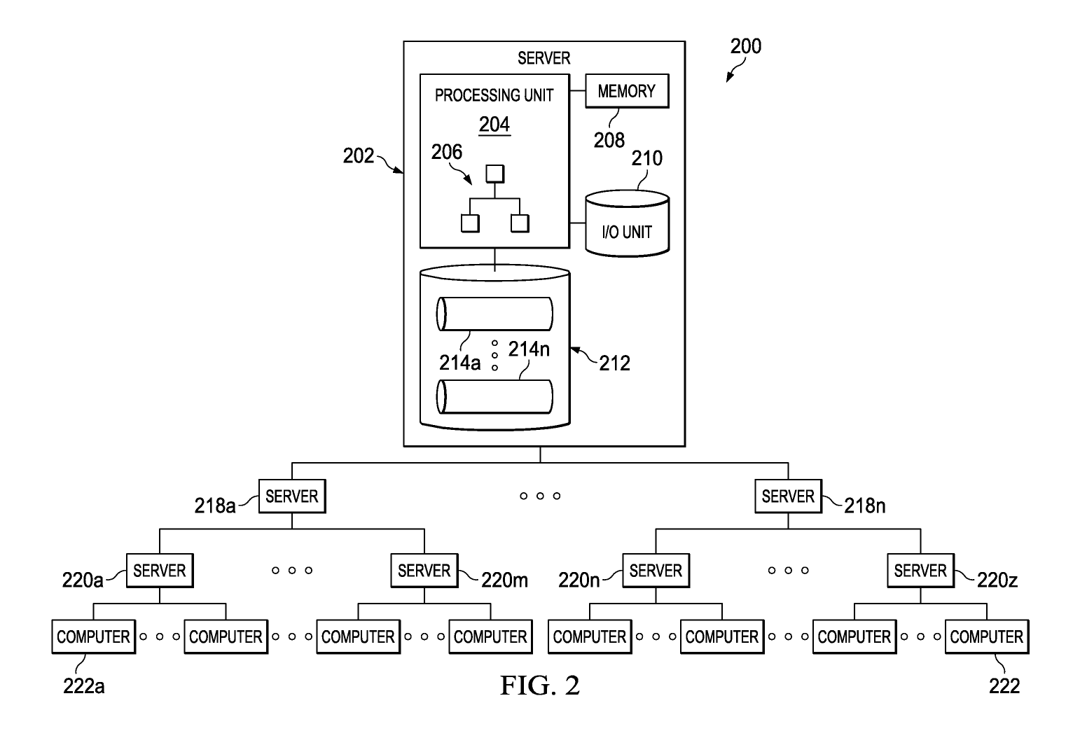

FIG. 2 is an illustration of an illustrative network configuration of the enterprise of FIG. 1;

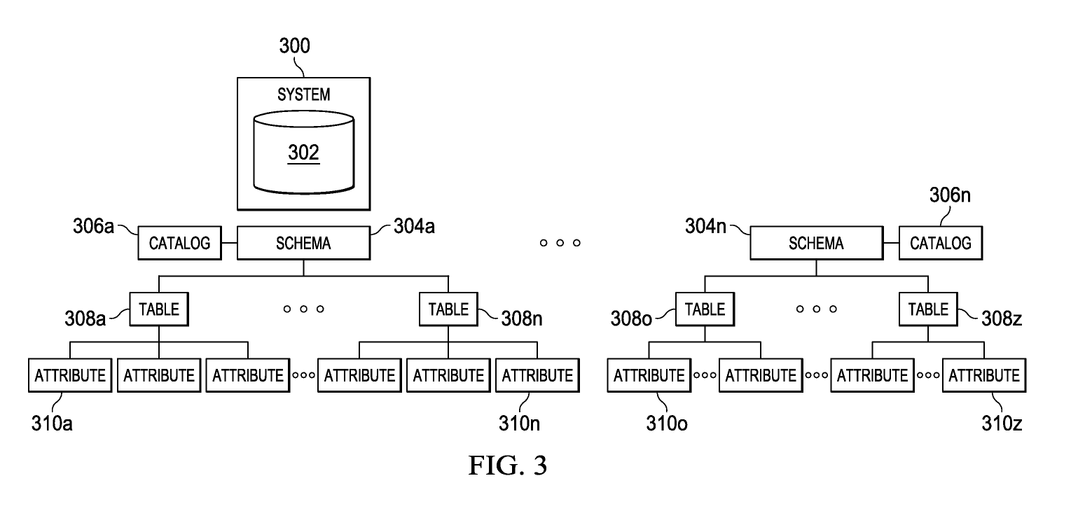

FIG. 3 is an illustration of an illustrative enterprise information management system inclusive of a data repository, as understood in the art;

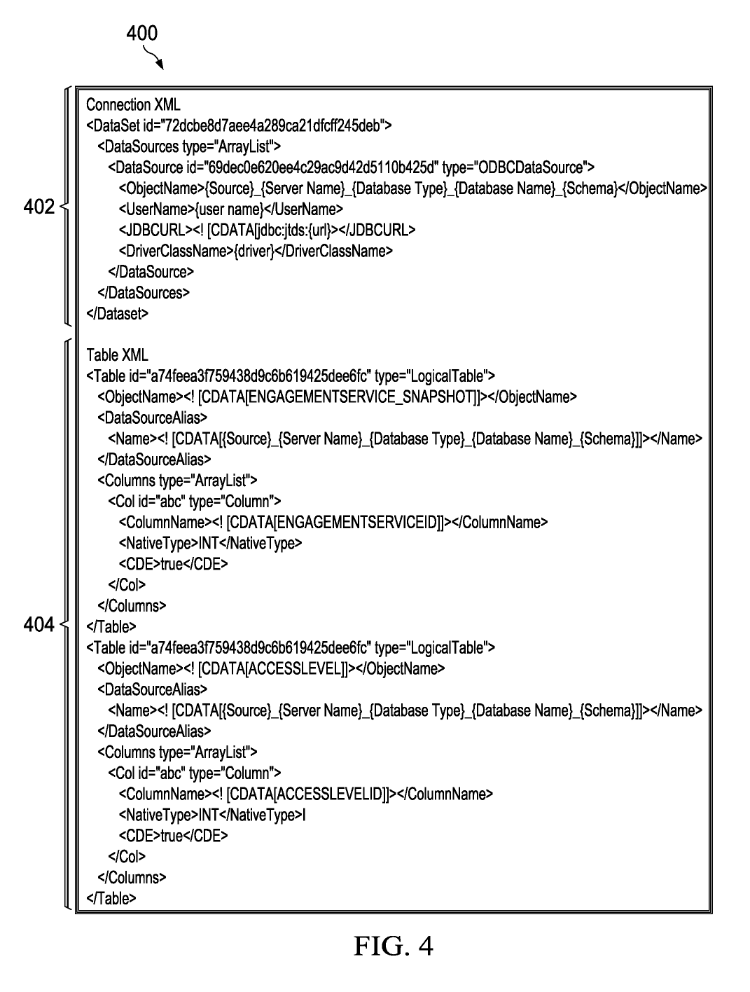

FIG. 4 is an illustrative XML file used to provide database connection parameters to a database or database and schema (undirected), or subset of table connection parameters within a schema (directed);

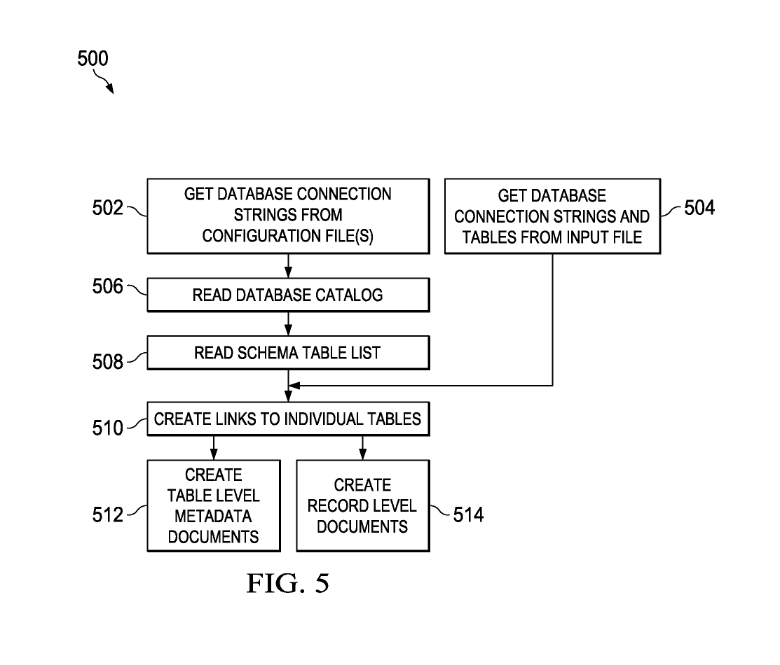

FIG. 5 is a flow diagram of an illustrative process for automatically creating connections to tables of a data repository in accordance with the principles of the present invention; and

FIG. 6 is a block diagram of illustrative modules executable by a computing system for automatically creating connections to tables in order to extract data values and metadata associated with the data values in the tables.

### DETAILED DESCRIPTION OF THE DRAWINGS

With regard to FIG. 1, an illustration of an illustrative hierarchical structure 100 of an enterprise, such as a corporation or governmental entity, is shown. The structure 100 may include an enterprise headquarters 102 that includes multiple divisions 104a-104n (collectively 104). Each of the divisions 104 may include multiple facilities 106a-106m and 106n-106z, respectively (collectively 106). As understood in the art, each of the enterprise headquarters 102, divisions 104, and facilities 106 may utilize distinct data repositories, and possibly distinct information management systems, for collecting, managing, and processing operational data of the enterprise. For example, the operational data may include customer names, customer addresses, customer policies (in the case of an insurance company), customer payments, and so forth.

Because enterprises, especially large, multi-national enterprises, often use different enterprise management systems with data repositories, such as SAP, Oracle, and other enterprise-scale information management systems, management of respective information management systems, naming conventions, data structures, and a variety of other aspects of managing information of the enterprise 100 may vary. As a result of local management of information management systems, the ability for enterprise-level information that enables senior management to quickly access and generate enterprise-level information (e.g., total sales revenue) is typically not possible. It is not uncommon for such enterprise-level information to take upwards of 9 to 12 months to be generated as a result of enterprise management systems having hundreds or thousands of tables being used within one or more data repositories to manage operational data of the enterprise. Such limitations are often a result of legacy information management systems being utilized by large enterprises, but such limitations may also exist due to the nature of enterprise information management systems, legacy or current.

With regard to FIG. 2, an illustration of an illustrative network 200 configuration of the enterprise of FIG. 1 is shown. The network configuration 200 may include a server 202 inclusive of a processing unit 204 that may include one more computer processors, as understood in the art. The processing unit 204 may be configured to execute software 206 to perform functions in accordance with the principles of the present invention. The processing unit 204 may be in communication with a memory 208 to store data and/or software, as understood in the art. The processing unit 204 may be in communication with an input/output (I/O) unit 210 configured to communicate data via a communications network and a storage unit 212. The storage unit 212 may be configured to store data repositories 214a-214n (collectively 214). The data repositories 214 may be configured to store enterprise-level information along with tables that may be collected from data repositories of lower-level enterprise operations. The tables may be collected into a single network location or be maintained as originally configured by the enterprise in their native format. The network configuration 200 may further include servers 218a-218n (collectively 218) that may be operated at a division level, such as divisions 104 of FIG. 1. Servers 220a-220m and 220n-220z (collectively 220) may be operated at a facility level, such as facilities 106 of FIG. 1. Computers 222a-222n (collectively 222) may be individual computers, such as point-of-sale devices, personal computers, and/or any other computing or data collection/generation device or system, as understood in the art. The computers 222 may be in communication with local servers 220 that may have enterprise information management systems used to collect and inventory and/or aggregate data of each facility. As understood in the art, individual facilities often utilize and maintain separate information management systems. Still yet, divisions of enterprises may operate independent of other divisions, especially when each of the divisions operate in different geographic regions, such as different countries, from other divisions.

The illustrative network configuration shows four levels of computing systems. It should be understood that many more levels and layers of complexity of network architecture is often used within large enterprises, which creates a data repository, such as a relational database, that has hundreds or thousands of tables in which information generated by each facility of an organization is stored. As an example, in the case of a multi-national retail operation, such as a retail store, sales of clothing and other products may be generated in vast amounts. Moreover, information of customers may be collected and stored for a variety of different purposes, including returns, marketing, demographic assessment, and many other reasons, as understood in the art. The reason for a data repository utilizing hundreds or thousands of tables is to be able to provide for fast querying or perform other functions in a fast manner within the information management system. In other words, many data repositories of information management systems utilize relatively “shallow” tables, but use the many tables so as to increase the speed of searching for data contained therein. As a result, however, the ability to (i) keep track of names and locations of tables, (ii) know what data is in each table, and (iii) aggregate the data from each of the tables can be incredibly time consuming and difficult. In addition, and as previously described, the ability to connect to each table to be able to access and collect the data from each table can be very time consuming.

With regard to FIG. 3, an illustration of an illustrative enterprise information management system 300 inclusive of a data repository 302, as understood in the art, is shown. The data repository 302 may include a set of schemas 304a-304n (collectively 304), where schemas 304 are associated with (i) respective catalogs 306a-306n (collectively 306) that includes a list of table names and/or pointer values contained therein and (ii) respective groups of tables 308a-308n (collectively 308). As understood in the art, a catalog is a reference for all data in a system and operates as a reference lookup by including lists of schemas and tables associated with respective schemas. Tables 308 may be configured to store data values, and include attributes 310a-310n (collectively 310) that define attributes of data elements contained in the respective tables 308. The number of tables 308 may depend on the data repository (e.g., SAP, Oracle, etc.), size of the enterprise, configuration of the enterprise, geographic diversity of the enterprise, configuration of the data repository 302, configuration of the tables 308, and so forth. As further shown schema 304n is associated with catalog 306n, tables 308o-308z, and attributes 310o-310z, and the principles of the present invention operate to automatically create connections to each table for all schemas in the one or more data repositories.

As understood in the art, and as previously described, the number of data repositories of a relatively large enterprise may range upwards of 100,000, and be used to store operational data of the enterprise, such as an accounting firm, retail chain, or otherwise. It should also be understood that not all enterprises use a single or common information technology platform for managing operational and other data, which compounds the problem of creating connections to and extracting data from the tables. Moreover, as a result of utilizing the principles of the present invention, the time to create connections to each of the tables may be reduced from five minutes to milliseconds, and an entire set of tables may be reduced from weeks or months to a few minutes, which is a significant reduction in both time and expense.

With regard to FIG. 4, an illustrative XML file 400 used to provide database connection parameters 402 to a schema (undirected) or subset of table connection parameters (404a and 404b (collectively 404) within a schema (directed) is shown. The database connection parameters 402 may be derived from catalogs 306 (FIG. 3) associated with each schema 304 of a data repository 302. The database connection parameters 402 may be utilized by a software program to create a conduit to the data repository by which data, both data values and metadata within each of the tables, may be collected through an automated gathering process provided in FIG. 5. More specifically, the database connection parameters 402 may be used to point to a data repository so that catalogs associated with schemas in the data repository can be accessed and read to create a list of tables being maintained in the data repository.

Two subsets of table connection parameters 404 shown provide table IDs (“<objectName>”) and connections at a schema level (“<DataSourceAlias>”), and be provided to a process to expedite identification of tables that are a subset of tables in the catalog(s) of the data repository. This process can be used if a user knows which specific tables within a data repository are going to be used for gathering data rather than creating connections to all of the tables, a subset of connections may be provided by the table connection parameters 404. The subset of table connection parameters 404 may be created automatically utilizing a data crawling process, as provided in co-pending U.S. patent application having Ser. No. 14/297,543 filed Jun. 5, 2014 entitled “System and Method for Finding and Inventorying Data from Multiple, Distinct Data Repositories,” the contents of which are hereby incorporated by reference in their entirety. The connection parameters 402 may use an XPATH format or any other link or connection format, as understood in the art. Connection data, which may include certain components of the subset of table connection parameters 404 or table information extracted from catalogs of the data repository, may be created, stored, and used during runtime. The connection data, which may be created automatically utilizing the principles of the present invention, may include code that is utilized during runtime to cause a process or system to access tables associated with the connection data.

With regard to FIG. 5, a flow diagram of an illustrative process 500 for automatically creating connections to tables of a data repository in accordance with the principles of the present invention is shown. The process 500 is shown to include two paths, including an “undirected” path starting at step 502 and a “directed” path starting at step 504. In the “undirected” path, the process may start at step 502, where a pointer or connection string to a data repository may be established. In establishing the pointer, an XML file or other formatted file may include connection parameters, such as connection parameters 402 (e.g., IP address, database name, schema name) of FIG. 4. The pointer enables an automated solution for creating the connections to the tables in the data repository. The process 500 may continue at step 506, where each catalog inclusive of schemas and table names within each data repository may be read. At step 508, each schema table list may be read to obtain each of the table names, pointer addresses to the tables, and/or any other information, such as type, object type, etc. A connection, such as an XML connection, to each of the individual tables may be created at step 510. The links or connections created at step 510 may be created in non-transitory memory for later use in accessing the tables. The connections created at step 510 may thereafter be used by a data crawler process to identify related data, such as the process provided in co-pending U.S. patent application having Ser. No. 14/297,543. Any other process for creating connections may be utilized in accordance with the principles of the present invention. The process 500 may be performed for each schema/catalog combination in the data repository. The process 500 may also be used to count a number of tables from each catalog associated with respective schemas in each data repository along with a total number of tables. Additionally, the process 500 may be used to count the number of rows of data values in each table. The counts may provide for managing and error checking when access and processing data from the tables thereafter.

In the “undirected” path, the process may start at step 504, where database connection strings and tables may be obtained from an input table. In response to obtaining the connection strings, the module 504 may parse the connection strings or otherwise use identifiers to identify table connection parameters. Such an input table may include subsets of table connection parameters, such as the table connection parameters 404 shown in FIG. 4, that provide table names. The table connection parameters and connection strings may be created in an automated manner through use of a data crawler as provided in co-pending U.S. patent application having Ser. No. 14/297,543. Alternatively, the table connection parameters may be manually created. At step 510, connections to each of the individual tables may be created and stored in memory for use by another function that accesses each of the tables referenced by the connections.

In one embodiment, table level metadata documents may be created at step 512 and record level documents may be created at step 514 using the connections to the individual tables created at step 510. These documents may be utilized for generating enterprise-level information, such as overall business accounting information (e.g., total sales revenue), internal information (e.g., demographic landscape of all employees), etc. It should be understood that steps 512 and 514 are illustrative and that any additional and/or alternative processes for using the data of the tables may be utilized in accordance with the principles of the present invention.

In summary, the use of the process 500 may be used to (i) identify all data repositories in which tables used to manage data of an enterprise exist, (ii) create connections to each of the tables in the data repositories, (iii) build an inventory of the tables of interest, which may include a subset of the tables or all of the tables, and (iv) collect and process data values and metadata from each of the tables to generate information desired (e.g., total sales of an enterprise).

With regard to FIG. 6, a block diagram of illustrative modules 600 executable by a computing system for automatically creating connections to tables of a data repository and creating metadata and record documents is shown. The modules 600 may include an access data repository module 602 that may utilize a pointer to one or more data repositories that points to a header of the data repository(s), and from which, system-level metadata, such as catalogs may be identified and accessed. Alternatively, an input file may be provided to direct the process to a specific subset of tables within the data repository(s). A create connections module 604 may be configured to generate connections to each table for use by a software program in accessing content of the tables. The module 604 may create the connections using XML or any other protocol or computer readable language. A read catalog module 606 may be configured to read content of a catalog, including table name or any other information from the catalog or other metadata for use in creating connections to tables within the data repository. The module 606 may read and collect components for use in creating connections to the tables. A create links or connections to individual tables module 608 may be configured to create connections to the individual tables. The connections may be data stored in memory that is used during runtime that enables a system to access tables in the data repository. The module 608 may further be configured to write and/or store the connections that are created by the module 608. In one embodiment, the module 608 may also be configured to write and store other information, as well.

In addition to creating connections, the principles of the present invention may provide for creating data files associated with each table or one or more data files that is associated with multiple tables. The data file(s) may be used to copy data, both data values and metadata, contained in each of the tables. The data file(s) may be schema-less, and the data may have a schema-less format. Moreover, the data file(s) may not have a data format or be formatted. By copying the data from the tables into separate data file(s), faster processing of the data may be performed.

The previous description is of a preferred embodiment for implementing the invention, and the scope of the invention should not necessarily be limited by this description. The scope of the present invention is instead defined by the following claims.

What is claimed is:

1. A method for automatically establishing connections to tables within a data repository, said method comprising:
establishing, by a processing unit, a pointer to the data repository inclusive of the plurality of tables; and
automatically creating, by the processing unit, connections for the respective tables.

2. The method according to claim 1, further comprising:
accessing, by the processing unit, system-level metadata within a catalog of the data repository;
extracting, by the processing unit, the system-level metadata from the catalog; and
identifying, by the processing unit, connection data associated with a plurality of tables within the system-level metadata.

3. The method according to claim 1, wherein establishing a pointer to a data repository includes receiving connection parameters to a data repository.

4. The method according to claim 1, wherein the data repository is a relational database.

5. The method according to claim 1, further comprising:
creating, by the processing unit, a data file for each table and row of data within each table associated with each connection being created; and
populating, by the processing unit, the data files with data values and metadata being stored in the respective tables and rows.

6. The method according to claim 5, wherein populating the data files includes populating the data files in a schema-less data format.

7. The method according to claim 5, wherein populating the data files includes:
reading the tables;
extracting metadata from the tables;
generating code inclusive of the metadata; and
using the code at runtime to access the tables.

8. The method according to claim 1, further comprising:
identifying each table in a schema, schema in a catalog, and catalogs in the data repository; and
repeating accessing, extracting, identifying and automatically creating for each respective schema in the data repository connections for tables associated with each respective schema.

9. The method according to claim 8, further comprising:
counting, by the processing unit, a number of tables associated with each schema; and
computing, by the processing unit, a total number of tables in the data repository.

10. The method according to claim 1, wherein automatically creating connections includes automatically creating runtime code.

11. A method for automatically establishing connections to tables within a data repository, said method comprising:
establishing, by a processing unit, a pointer to the data repository inclusive of the plurality of tables;
accessing, by the processing unit, a catalog of the data repository;
reading, by the processing unit, table names from the catalog; and
automatically creating, by the processing unit, connections for the respective tables.

12. The method according to claim 11, further comprising:
receiving a file inclusive of table connection parameters;
identifying the table connection parameters; and
creating connections to the tables identified in the table connection parameters.

13. The method according to claim 11, wherein the data repository is a database.

14. The method according to claim 11, further comprising:
creating a data file for each table and data row within each table associated with each connection being created; and
populating the data files with data values and metadata being stored in the respective tables and rows.

15. The method according to claim 14, wherein populating the data files includes populating the data files in a schema-less data format.

16. The method according to claim 14, wherein populating the data files includes:
reading the tables;
extracting metadata from the tables;
generating code inclusive of the metadata; and
using the code at runtime to access the tables.

17. The method according to claim 11, further comprising:
identifying each table in a schema, schemas in a catalog, and catalogs in the data repository; and
repeating accessing, extracting, identifying and automatically creating for each respective schema in the data repository connections for tables associated with each respective schema.

18. The method according to claim 17, further comprising:
counting a number of tables associated with each schema; and
computing a total number of tables in the data repository.

19. The method according to claim 11, wherein automatically creating connections includes automatically creating runtime code.
